(19) United States
(12) Patent Application Publication
(10) Pub. No.: US 2017/0285908 A1
(43) Pub. Date: Oct. 5, 2017

(54) USER INTERFACE THROUGH REAR SURFACE TOUCHPAD OF MOBILE DEVICE

(71) Applicant: Sanghak KIM, Yongin-shi (KR)

(72) Inventor: Sanghak KIM, Yongin-shi (KR)

(21) Appl. No.: 15/629,774

(22) Filed: Jun. 22, 2017

Related U.S. Application Data
(63) Continuation-in-part of application No. PCT/KR2015/010876, filed on Oct. 15, 2015.

(30) Foreign Application Priority Data
Oct. 2, 2015 (KR) 10-2015-0139078

(51) Int. Cl. G06F 3/0488; H04M 1/02; G06F 3/0484; G06F 3/041; G06F 3/0481

(52) U.S. Cl. CPC G06F 3/0488; G06F 3/0412; G06F 3/0481; G06F 3/0484; G06F 3/04886; H04M 1/0202

(57) ABSTRACT

According to an embodiment of the present disclosure, an electronic device, e.g., the mobile device, may comprise an input unit disposed on a first surface of the electronic device to receive a first signal, an output unit outputting a second signal and displaying a first user interface, a second user interface disposed on a second surface of the electronic device to receive a third signal, and a controller configured to perform a first operation according to the first signal, a second operation according to the second signal, and a third operation according to the third signal, wherein the third operation includes controlling the first user interface.

### CROSS-REFERENCE TO RELATED APPLICATIONS

This patent application is a continuation-in-part of International Patent Application No. PCT/KR2015/010876, which claims priority under 35 U.S.C. §119 to Korean Patent Application No. 10-2015-0139078, filed on Oct. 2, 2015, in the Korean Intellectual Property Office, the disclosures of which are incorporated by reference herein in their entireties.

### TECHNICAL FIELD

Embodiments of the present disclosure concern mobile communications technology, and more specifically, to a user interface for use in mobile devices.

### DISCUSSION OF RELATED ART

The user interface (UI), in the industrial design field of human-computer interaction, is the space or a software/hardware device where interactions between humans and machines occur. The goal of this interaction is to allow effective operation and control of the machine from the human end, whilst the machine simultaneously feeds back information that aids the operators' decision-making process. Examples of this broad concept of user interfaces include the interactive aspects of computer operating systems, hand tools, heavy machinery operator controls, and process controls. The design considerations applicable when creating user interfaces are related to or involve such disciplines as ergonomics and psychology.

As mobile device industry grows and develops, more demand is directed to easier control or manipulation of mobile devices, and significant research efforts are underway for mobile user interfaces.

A mobile user interface (MUI) is the graphical and usually touch-sensitive display on a mobile device, such as a smartphone or tablet PC, that allows the user to interact with the device's apps, features, content and functions and to control the device.

Mobile user interface design requirements are significantly different from those for desktop computers. The smaller screen size and touch screen controls create special considerations in UI design to ensure usability, readability and consistency. In a mobile interface, symbols may be used more extensively and controls may be automatically hidden until accessed.

Conventional techniques for mobile user interfaces fail to respond to the demand of easier and simpler manipulation of mobile devices in light of the nature of MUI technology.

### SUMMARY

According to an embodiment of the present disclosure, an electronic device, e.g., the mobile device, may comprise an input unit disposed on a first surface of the electronic device to receive a first signal, an output unit outputting a second signal and displaying a first user interface, a second user interface disposed on a second surface of the electronic device to receive a third signal, and a controller configured to perform a first operation according to the first signal, a second operation according to the second signal, and a third operation according to the third signal, wherein the third operation includes controlling the first user interface.

According to an embodiment of the present disclosure, a method for controlling an electronic device comprises displaying a first user interface on a display formed on a first surface of the electronic device, receiving a control signal from a second user interface formed on a second surface of the electronic device, wherein the control signal is generated by at least one of touching or tapping on the second user interface with an object, displaying a cursor on the first user interface according to the control signal, and controlling the first user interface using the cursor, wherein the cursor is moved on the first user interface according to a movement of the object on the second user interface so that the cursor is controlled to perform a predetermined operation of the first user interface.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating an example of controlling a mobile device using a front user interface according to the prior art;

FIG. 2 is a block diagram illustrating a mobile device having a rear user interface according to an embodiment of the present disclosure;

FIG. 3 is a front view illustrating an example of controlling a mobile device using a rear user interface according to an embodiment of the present disclosure;

FIG. 4 is a rear view illustrating an example of controlling a mobile device using a rear user interface according to an embodiment of the present disclosure; and

FIG. 5 is a flowchart illustrating a method for operating a rear user interface of a mobile device according to an embodiment of the present disclosure.

### DETAILED DESCRIPTION OF EXEMPLARY EMBODIMENTS

Hereinafter, exemplary embodiments of the present disclosure will be described in detail with reference to the accompanying drawings. Like reference denotations may be used to refer to like or similar elements throughout the specification and the drawings. The present disclosure, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

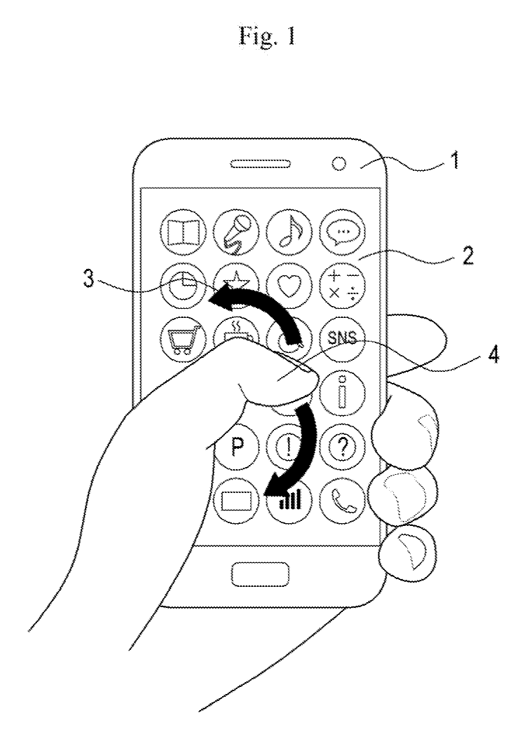

FIG. 1 is a view illustrating an example of controlling a mobile device using a front user interface according to the prior art.

Referring to FIG. 1, a mobile device 1 includes an output unit, e.g., a display, which may be a liquid crystal display (LCD) or an organic light emitting diode (OLED) display. A front user interface 2 is displayed on the display. The front user interface 2 includes a plurality of icons (or widgets) 3 respectively corresponding to particular applications (simply referred to as apps) that may respectively perform functions or operations.

A user may touch or tap on an icon 3 with his finger 4 to perform a particular operation corresponding to the icon 3. For example, the user may view the current time by touching a clock icon 3. Or, the user may listen to music by touching an icon 3 for a music player application.

However, such a conventional-type front user interface 2 has an area that is hard to reach by the user's finger 4, e.g., the thumb, causing inconvenience in one-handed control of the mobile device 1. For example, the user who holds the mobile device 1 with one hand cannot help using the other hand to touch a chat icon for running a chat application, which is too far to reach.

Even when the chat icon can be reached and touched with the thumb of the hand, it is still uncomfortable because the user may be required to change the position of the hand and re-hold the mobile device 1. During the course, the user may even drop the mobile device 1. In this regard, a need exists for other types of user interfaces that allow for easier one-handed control or manipulation of a mobile device 1.

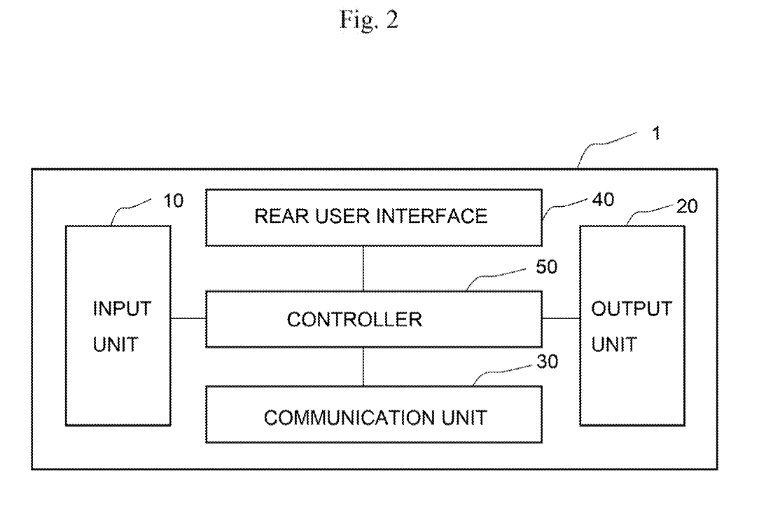

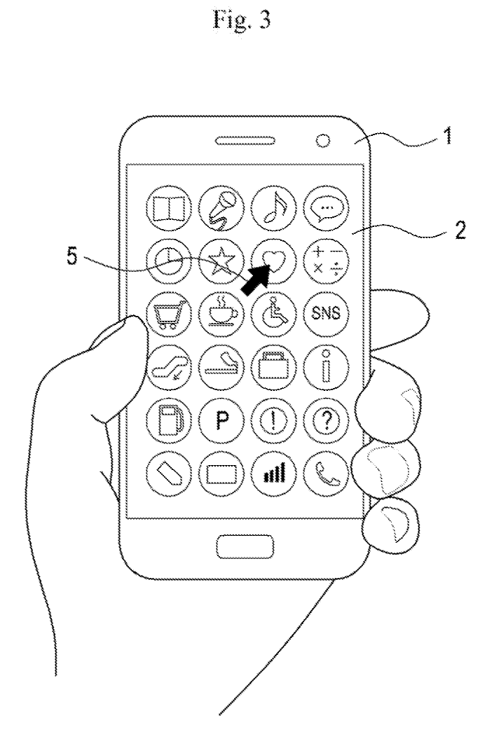

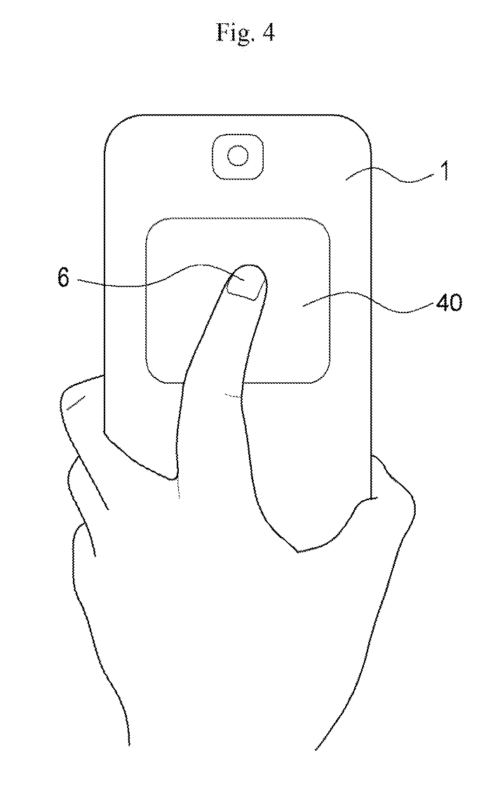

FIG. 2 is a block diagram illustrating a mobile device having a rear user interface according to an embodiment of the present disclosure. FIG. 3 is a front view illustrating an example of controlling a mobile device using a rear user interface according to an embodiment of the present disclosure. FIG. 4 is a rear view illustrating an example of controlling a mobile device using a rear user interface according to an embodiment of the present disclosure.

According to an embodiment of the present disclosure, a mobile device 1 includes an input unit 10, an output unit 20, a communication unit 30, a rear user interface 40, and a controller 50.

The input unit 10 may include, but is not limited to, a microphone, a keyboard, a mouse, or a touchscreen. The input unit 10 receives a signal from a user and transmits the signal to the controller 50. For example, the input unit 10 may receive a control signal from a user and transmit the control signal to the controller 50 so that the controller 50 may issue a particular command to perform a particular operation.

The output unit 20 may include, but is not limited to, a display or a speaker. When the output unit 20 is implemented to be a display, the output unit 20 displays an image or video under the control of the controller 50. When the output unit 20 is implemented to be a speaker, the speaker outputs a voice or sound under the control of the controller 50. The output unit 20 may display a front user interface 2 for control of various apps or settings of the mobile device 1.

The communication unit 30 may include a signal transmitting unit and a signal receiving unit. The signal transmitting unit sends out signals under the control of the controller 50, and the signal receiving unit receives signals from the outside through an antenna under the control of the controller 50.

The rear user interface 40 may include a touchpad or a touchscreen, but without limited thereto. The rear user interface 40 may receive a touch or tap by a user, e.g., the user's finger 6 or an object, and converts the received touch or contact into an electrical signal under the control of the controller 50. The electrical signal is transmitted to the controller 50. The controller 50 performs an operation or function corresponding to the received electrical signal.

For example, the controller 50 may activate the control of the rear user interface 40 when the user touches the rear user interface 40 with his finger 6, e.g., the index finger or middle finger.

For example, when the user slides, on the rear user interface 40 in a predetermined direction, his index finger 6 which is positioned on the back of the mobile device 1, an operation corresponding to such sliding may be performed as if it is done so by sliding on the front user interface 2.

For example, when the user touch or taps on a particular point in the rear user interface 40, the controller 50 may determine the position of the touched point and activate or run an application of an icon that is located corresponding to the position of the touched point. By way of example, the rear user interface 40 is touched or tapped on a predetermined point, the controller 50 may determine the coordinates of the touched or tapped point and perform an operation that is to be performed at coordinates on the front user interface 2 corresponding to the coordinates of the touched point.

Such a touch or tap on the rear user interface 40 as to run the application may be a single-touch, single-tap, double-touch, or double-tap action, but is not limited thereto.

According to an embodiment of the present disclosure, the controller 50 may perform control so that a touch (or tap or contact, but not limited thereto) on the rear user interface 40 by a finger 6 may enable a cursor 5, such as that of a mouse shown on the computer screen, to show up on the front user interface 2 of the mobile device 1. For example, a cursor 5 shaped as an arrow may be displayed as shown in FIG. 3. As the finger 6 slides on the rear user interface 40 while touching the rear user interface 40, the cursor 5 may move accordingly in the direction along which the finger slides. When the finger 6 stops at a particular position on the rear user interface 40, the cursor 5 may also stop at a position corresponding to the position of the finger on the front user interface 2. For example, the user may run his thumb on the rear user interface 40 while viewing the front user interface 2 and stop the finger 6 when the cursor 5, which moves as the finger 6 does, is located on a particular icon, e.g., a chat icon for a chat application. The user may instantly take the finger 6 off the rear user interface 40 and retouch the rear user interface 40 at the same position to activate and run the chat application as if, in a computer application, an icon on which a mouse curse is laid is selected and its corresponding application is executed by clicking on the icon. Or, the user may activate and run the chat application by double-touching the rear user interface 40 at the same position.

As such, the controller 50 may activate and display a cursor 5 on the front user interface 2 when the user touches or taps on the rear user interface 40 and enables, through the cursor 5, various operations, e.g., selection, deselection, or move of an icon or running application, or other various operations.

The cursor 5 may be set to disappear unless a subsequent touch or other actions are carried out within a predetermined time.

The rear user interface 40 enables operations, which the front user interface 2 is to do, to be performed under the control of the controller 50.

The user may control the mobile device 1 using the rear user interface 40 independently from or along with the front user interface 2.

The front user interface 2 may be a touchscreen that receives a command from the controller 50 and performs an operation according to the received command. The rear user interface 40 may be implemented to operate in substantially the same manner as the front user interface 2.

According to an embodiment of the present disclosure, the front user interface 2 may be a touchscreen or a graphical user interface (GUI) displayed on the display of the mobile device 1, and the rear user interface 40 may be, e.g., a touchpad or a touchscreen.

The controller 50 may perform control so that the front user interface 2 and the rear user interface 40 are operated together or substantially simultaneously or so that the front user interface 2 stops operating when the rear user interface 40 is performed.

According to an embodiment of the present disclosure, the rear user interface 40 may be set by the controller 50 to be activated or operated when touched by a particular object that is previously registered, but not by other objects that are not registered. For example, the controller 50 may perform a procedure for registering an object by which the operation of the rear user interface 40 may perform its functions. The registering procedure may be, e.g., a fingerprint registration process.

The rear user interface 40 may be disposed at a predetermined position on the back of the mobile device 1. The predetermined position may be an area of the back of the mobile device 1, which may easily be reached, touched, or tapped by the user's finger(s), e.g., the user's index finger or middle finger. For example, the rear user interface 40 may be positioned at an upper side of the back of the mobile device 1 as shown. However, the rear user interface 40 is not limited as being placed at the position. The rear user interface 40 may be sized or dimensioned to enable easy touch or tap thereon by the user's finger(s). For example, the rear user interface 40 may be shaped as a rounded-corner rectangle as shown, but without limited thereto, its shape may be a rectangle, triangle, circle, ellipse, trapezoid, or any other shapes as long as easier control of the rear user interface 40 is possible by the shape.

The controller 50 may previously set up an active mode to activate the rear user interface 40 to operate. For example, the user may sometimes wish to perform control with the front user interface 2, but not with the rear user interface 40. For example, the controller 50 may set a mode in which the rear user interface 40 remains inactive as default in which case the user may activate the rear user interface 40 to operate by conducting a predetermined action, such as, e.g., touching or tapping on the rear user interface 40 a predetermined number of times or swiping on the rear user interface 40 in a predetermined direction. Alternatively, the rear user interface 40 may be set by the controller 50 to stay active in which case the user may deactivate the rear user interface 40 by a predetermined action which includes, or substantially similar to, the above-mentioned action to activate the rear user interface 40.

According to an embodiment of the present disclosure, an electronic device, e.g., the mobile device 1, may comprise an input unit 10, e.g., a touchscreen, disposed on a first surface, e.g., the front surface, of the electronic device to receive a first signal, e.g., a touch or tap, an output unit 20, e.g., a display, outputting a second signal, e.g., a sound or image, and displaying a first user interface, a second user interface, e.g., the rear user interface 40, disposed on a second surface, e.g., the rear surface, of the electronic device to receive a third signal, e.g., a touch or tap, and a controller 50 performing a first operation according to the first signal, a second operation according to the second signal, and a third operation according to the third signal, wherein the third operation includes controlling the first user interface. The first operation may include, but is not limited to, running an application, switching webpages, enabling text entry, or other various operations that may be performed on the screen of the mobile device 1. The second operation may include, but is not limited to, outputting a voice, a sound, an image, a video, or other various operations that may be performed through an output unit 20, e.g., a speaker or display of the mobile device 1.

The third operation may include, but is not limited to, running an application, switching webpages, enabling text entry, or other various operations that may be performed on the screen of the mobile device 1.

According to an embodiment of the present disclosure, the third operation may be performed independently from or along with the first operation.

According to an embodiment of the present disclosure, the third signal may include an electrical signal generated by at least one of a touch, a tap, a contact, or a slide on the second user interface.

According to an embodiment of the present disclosure, the controller 50 may determine a position (e.g., coordinates or coordinates information) where the electrical signal is generated and perform a particular function that corresponds to the determined position.

According to an embodiment of the present disclosure, the particular function may be performed by an application associated with an icon that is displayed on the first user interface and is positioned corresponding to the determined position.

According to an embodiment of the present disclosure, the controller 50 may perform control so that a cursor 5 is displayed on the first user interface when the second user interface is touched or tapped by an object at a particular position of the second user interface.

According to an embodiment of the present disclosure, the controller 50 may perform control so that, as the object moves in a predetermined direction, the cursor 5 is moved accordingly in the predetermined direction.

According to an embodiment of the present disclosure, the object may include, e.g., a user's finger.

According to an embodiment of the present disclosure, the electronic device may include, but is not limited to, a mobile device, a portable device, a mobile terminal, a handheld computer, or a personal digital assistant (PDA), a navigation device.

According to an embodiment of the present disclosure, the second surface may be an opposite surface of the first surface. For example, the first surface may be the front surface of the mobile device 1, and the second surface may be the rear surface of the mobile device 1.

According to an embodiment of the present disclosure, the second user interface may include, but is not limited to, at least one of a touchpad or a touchscreen.

According to an embodiment of the present disclosure, the input unit 10 may be formed on the output unit 20.

As such, the user of the rear user interface 40 allows the user to control the rear user interface 40 in a more convenient manner without the concern of dropping the mobile device 1 or repositioning his hand holding upon one-handed use of the mobile device 1.

The controller 50 controls the overall operation of the other elements of the mobile device 1. For example, the controller 50 may control the front user interface 2, the rear user interface 40, the input unit 10, the output unit 20, and the communication unit 30. The controller 50 may be a processor, a micro-processor, or a central processing unit (CPU), but is not limited thereto.

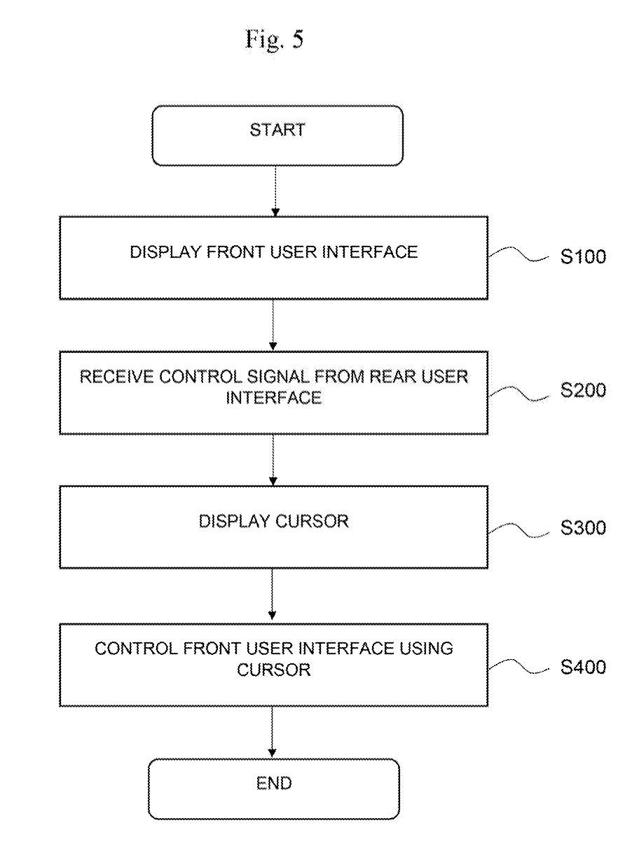

FIG. 5 is a flowchart illustrating a method for operating a rear user interface 40 of a mobile device according to an embodiment of the present disclosure.

According to an embodiment of the present disclosure, there is provided a method for controlling an electronic device.

In operation S100, the controller 50 displays a front user interface 2 on a display formed on a first surface of the electronic device.

In operation S200, the controller 50 receives a control signal from a rear user interface 40 formed on a second surface of the electronic device. The first surface of the electronic device may be the front surface of the electronic device, and the second surface of the electronic device may be the rear surface of the electronic device. The control signal may be generated by at least one of, e.g., touching or tapping on the second user interface with an object. The object may be, e.g., the user's finger. However, embodiments of the present disclosure are not limited thereto, and the object may be anything that may enable the controller 50 to generate a command or control signal when the objects touches or taps on the rear user interface 40 of the electronic device.

In operation S300, the controller 50 displays a cursor 5 on the first user interface according to the control signal. Although the cursor 5 is used herein, any other types of interfacing images, icons, symbols, or other graphical interfaces may be used instead of the cursor 5.

In operation S400, the user controls the mobile device 1 using the cursor 5. For example, the user may control the first user interface using the cursor 5.

In this case, the cursor 5 may perform various functions as the user touches, taps, or slides on the rear user interface 40. For example, when the user touches or taps on the rear user interface 40 with his index finger 6, the cursor 5 may be shown on the front user interface 2. For example, when the user slides the index finger 6 on the rear user interface 40, the cursor 5 may be moved along the direction in which the finger 6 moves. For example, when the user touches (or double-touches) on the rear user interface 40, the cursor 5, which is positioned on a particular icon associated with an application, may be clicked to execute the application. In the above examples, the description is made of moving the cursor 5 and running an application. However, embodiments of the present invention are not limited thereto. The user may perform other various operations by manipulating the cursor 5 using the rear user interface 40.

For example, the controller 50 moves the cursor 5 on the first user interface according to a movement of the object on the second user interface so that the cursor 5 is controlled to perform a predetermined operation of the first user interface. The cursor 5 may be enabled to select, release of the selection of, or move an icon on the front user interface 2 by touching, tapping, or sliding or swiping on the rear user interface 40. When the cursor 5 displayed is positioned on a particular icon, e.g., a chat icon associated with a chat application, the controller 50 enables the chat application to be executed when the user single-taps or double-taps on the rear user interface 40.

The predetermined operation includes at least one of selection, deselection, execution, or any other types of controls of the first user interface or an application associated with an icon displayed on the first user interface.

The application is run by touching or tapping on the second user interface when the cursor 5 is positioned on the icon.

For illustration purposes, it is assumed that a chat icon associated with a chat application is displayed at coordinates (x1,y1) on the front user interface 2, that coordinates (x1,y1) correspond to coordinates (X1,Y1) on the rear user interface 40, and that a double-tap action corresponds to running an application.

In such case, when the user double-taps on the coordinates (X1,Y1) point of the rear user interface 40 with his index finger, the double-tapping is converted into an electrical signal by the rear user interface 40 under the control of the controller 50.

The controller 50 receives the electrical signal, determines the position, e.g., coordinates (X1,Y1) from the received electrical signal, and generates a command associated with the double-tapping, e.g., to run an application. The command is delivered to the front user interface 2, and the front user interface 2 performs an operation according to the command. In other words, the front user interface 2 may run the chat application the corresponding icon of which is positioned at coordinates (x1,y1) which correspond to the position (X1,Y1) of the rear user interface 40.

Although a tap-and-run app operation has been described supra for exemplary purposes, embodiments of the present disclosure are not limited thereto. Substantially the same principle may also apply when the user swipes or slides on the rear user interface 40 so that a corresponding operation is performed on the front user interface 2.

Although not shown, the method may further include an operation for activating the rear user interface 40 to operate, in which the rear user interface 40 is set to remain inactive as default, or the method may further include an operation for deactivating the rear user interface 40 to stop operating, in which the rear user interface 40 is set to remain active as default.

As set forth above, according to the embodiments of the present disclosure, the rear user interface 40 allows for easier manipulation or control of the mobile device 1.

While the present disclosure has been shown and described with reference to exemplary embodiments thereof, it will be apparent to those of ordinary skill in the art that various changes in form and detail may be made thereto without departing from the spirit and scope of the present disclosure as defined by the following claims.

What is claimed is:

1. An electronic device, comprising:
an input unit disposed on a first surface of the electronic device to receive a first signal;
an output unit outputting a second signal and displaying a first user interface;
a second user interface disposed on a second surface of the electronic device to receive a third signal; and
a controller configured to perform a first operation according to the first signal, a second operation according to the second signal, and a third operation according to the third signal, wherein the third operation includes controlling the first user interface.

2. The electronic device of claim 1, wherein the third operation is performed independently from or along with the first operation.

3. The electronic device of claim 1, wherein the third signal includes an electrical signal generated by at least one of a touch, a tap, a contact, or a slide on the second user interface.

4. The electronic device of claim 3, wherein the controller determines a position where the electrical signal is generated and performs a particular function that corresponds to the determined position.

5. The electronic device of claim 4, wherein the particular function is performed by an application associated with an icon that is displayed on the first user interface and is positioned corresponding to the determined position.

6. The electronic device of claim 1, wherein the controller performs control so that a cursor is displayed on the first user interface when the second user interface is touched or tapped by an object at a particular position of the second user interface.

7. The electronic device of claim 6, wherein the controller performs control so that, as the object moves in a predetermined direction, the cursor is moved accordingly in the predetermined direction.

8. The electronic device of claim 6, wherein the object includes a user's finger.

9. The electronic device of claim 1, wherein the electronic device includes a mobile device.

10. The electronic device of claim 1, wherein the second surface is an opposite surface of the first surface.

11. The electronic device of claim 1, wherein the second user interface includes at least one of a touchpad or a touchscreen.

12. The electronic device of claim 1, wherein the input unit is formed on the output unit.

13. A method for controlling an electronic device, the method comprising:
displaying a first user interface on a display formed on a first surface of the electronic device;
receiving a control signal from a second user interface formed on a second surface of the electronic device, wherein the control signal is generated by at least one of touching or tapping on the second user interface with an object;
displaying a cursor on the first user interface according to the control signal; and
controlling the first user interface using the cursor, wherein the cursor is moved on the first user interface according to a movement of the object on the second user interface so that the cursor is controlled to perform a predetermined operation of the first user interface.

14. The method of claim 13, wherein the predetermined operation includes at least one of controlling the first user interface and running an application associated with an icon displayed on the first user interface.

15. The method of claim 14, wherein the application is run by touching or tapping on the second user interface when the cursor is positioned on the icon.
